(19) United States
(12) Patent Application Publication
(10) Pub. No.: US 2004/0244149 A1
(43) Pub. Date: Dec. 9, 2004

(54) Hinge

(76) Inventor: Joseph Anscher, Muttontown, NY (US)

Correspondence Address: WILLIAM COLLARD, COLLARD & ROE, P.C., 1077 NORTHERN BOULEVARD, ROSLYN, NY, 11576, US

(21) Appl. No.: 10/453,949

(22) Filed: Jun. 4, 2003

(51) Int. Cl. E05D 5/10

(52) U.S. Cl. 16/386

(57) ABSTRACT

A hinged product has a first section and a second section. The first section has a post extending transversely across one end thereof. The second section two co-axial apertures therein, each of the apertures having an internal wall. The post extends between and through the apertures to connect the first section to the second section. There is at least one protrusion located on either the post or the internal walls of the apertures. There is at least one rib disposed the other of the internal walls or the post. The rib contacts the protrusion as the second section is rotated relative to the first section and causes resistance to rotation. This resistance allows for a stepped rotation of the two sections relative to one another. Depending on the arrangement of the apertures, the product could be placed in numerous configurations.

### BACKGROUND OF THE INVENTION

1. Field of the Invention

The invention relates to a hinge that is suitable for many uses, but is particularly suitable for use in rod clips that hold metal rods inside the door mechanisms of automobiles. In particular, the invention relates to a hinge that can be molded in one piece and which can be manufactured to have varying amounts of resistance between the two hinge portions.

2. The Prior Art

It is well known in the automotive industry to use rod clips to connect actuating rods to levers. This type of arrangement is especially common with door locking mechanisms and carburetor linkage arrangements. The clips are typically made of a plastic material and snap around the end of the rod. The lever is then snapped into a protrusion on the clip having a retaining lip or latches on its sides.

The clips can be manufactured as one piece with an integral “living hinge” or in two pieces with a connection mechanism connecting the two pieces. In general, the two-piece constructions are more durable, but can be difficult to mold and assemble because of the separate pieces.

In addition, the two-piece hinges generally have a lot of play between the two parts, and the interaction between the two parts is very loose.

It would be desirable to construct a rod clip or other item having a two-piece hinged construction that can be molded in one step, not require assembly, and which can have a varying amount of resistance between the two pieces to satisfy different requirements.

### SUMMARY OF THE INVENTION

The invention comprises a hinged product having a first section and a second section. The first section has a post extending transversely across one end. The second section has two co-axial apertures therein, each of the apertures having an internal wall. The post on the first section extends through the apertures in the second section to connect the first section to the second section. There is at least one protrusion located on either the post or the internal walls of the apertures. There is at least one rib disposed the other of the internal walls or the post. The rib contacts the protrusion as the second section is rotated relative to the first section and causes resistance to rotation. This resistance allows for a stepped or indexed rotation of the two sections relative to one another. Depending on the arrangement of the apertures, the product can be placed in numerous configurations.

Preferably, the protrusions are located on the aperture and the rib is disposed longitudinally along the post. Alternatively, the post could have protrusions disposed circumferentially around the outer ends of the post, and the inner walls of the apertures could be equipped with a single transverse rib.

In a preferred embodiment, the first section is integrally formed with the second section via at least one connection point connecting one of the protrusions and the post. Rotating the first section relative to the second section causes the connection point or points to break. Thus, a two-piece hinge can be manufactured as a single piece.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a perspective view of a first embodiment of the hinge according to the invention, embodied in a rod clip;

FIG. 2 shows an enlarged side view of the hinge according to FIG. 1;

FIG. 3 shows a side view of the embodiment of FIG. 2, with the hinge rotated 90 degrees;

FIG. 4 shows a cross-sectional view of the post and aperture arrangement of FIG. 3;

FIG. 5 shows a side perspective view of an alternative embodiment of the hinge according to the invention; and

FIG. 6 shows an enlarged side view of the hinge of FIG. 5.

### DETAILED DESCRIPTION OF THE PREFERRED EMBODIMENT

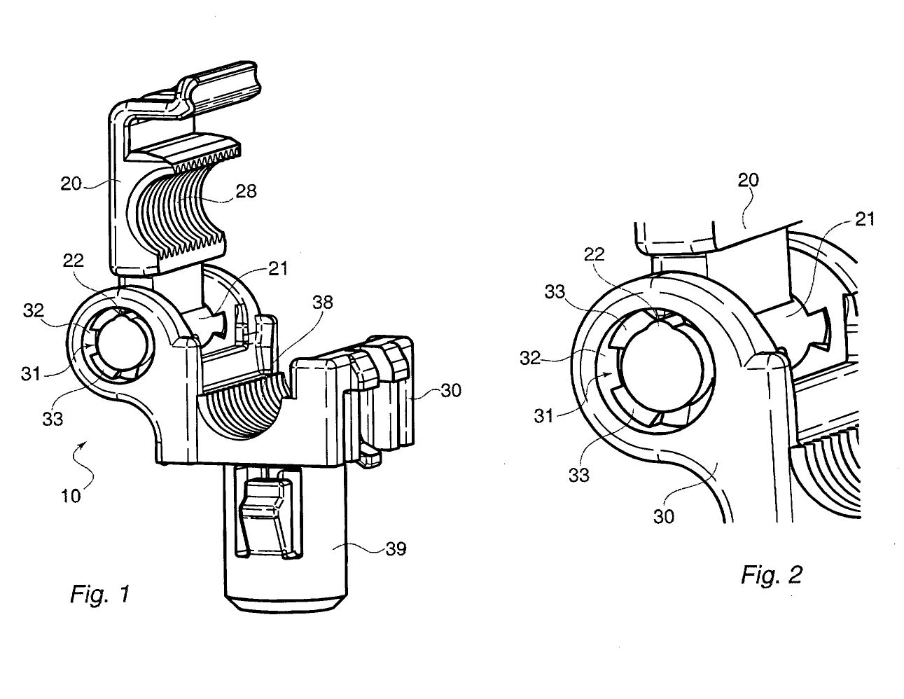

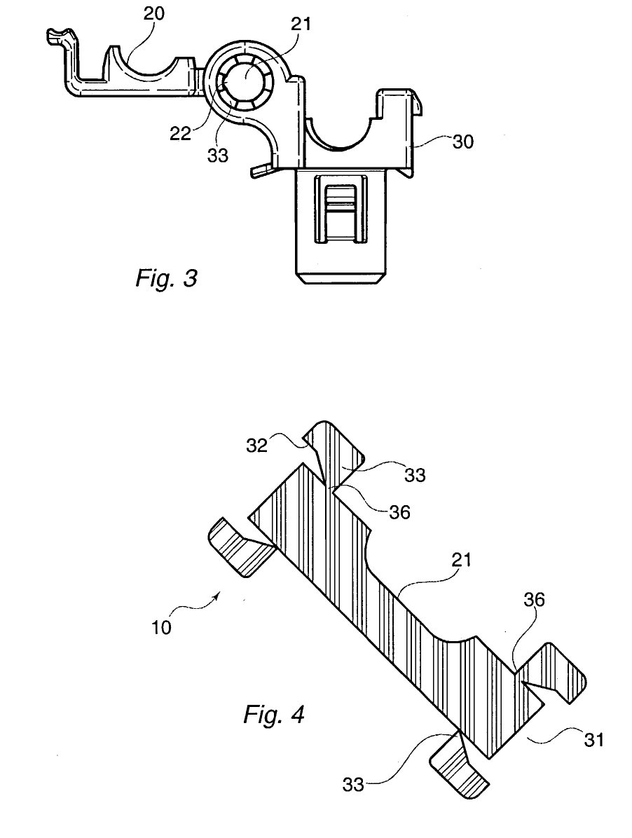

Referring now in detail to the drawings, FIGS. 1-3 show a preferred embodiment of the hinge according to the invention, as it is used on a rod clip 10. Rod clip 10 comprises a first section 20 that is hinged to a second section 30. First section 20 has a rod 21 that extends through two co-axial apertures 31 on second section 30. Rod 21 has a rib 22 extending longitudinally along its surface. Each aperture 31 has an inside wall 32 extending all around. Along inside wall 32 are a plurality of protrusions 33. As first section 20 is rotated relative to second section 30, rib 22 abuts protrusions 33 and resists the rotation. This way, the product can be placed in one of several different uniform orientations. Excess force is required to rotate the hinge beyond a resting position, because rib 22 must be forced past its adjacent protrusion 33. By varying the number and position of ribs 22 and protrusions 33, one can create a customized hinge having an unlimited variety of indexing positions. In the embodiment shown in FIGS. 1-3, there are four protrusions, and two different indexing positions are shown. In FIG. 1, first section 20 is placed perpendicular to second section 30. In FIG. 3, first section 20 is located parallel with second section 30. In an alternative embodiment, the protrusions are arranged around the ends of post 21 and the rib extends along inner wall 32, creating the same interaction between protrusions and rib as described above.

In a preferred embodiment, as shown in cross-section in FIG. 4, the entire rod clip 10 or other product is molded integrally as one piece, with connection points 36 connecting first section 20 to second section 30. Connection points 36 extend out from protrusions 33 located on inner wall 32 of aperture 31, and connect directly to post 21 on second section 20. This way, a single mold is required to mold the entire product. To use the hinge, connection points 36 are broken by rotating first section 20 relative to second section 30 until connection points snap. Then, the two sections are permanently separated from each other and function as a two-piece hinge.

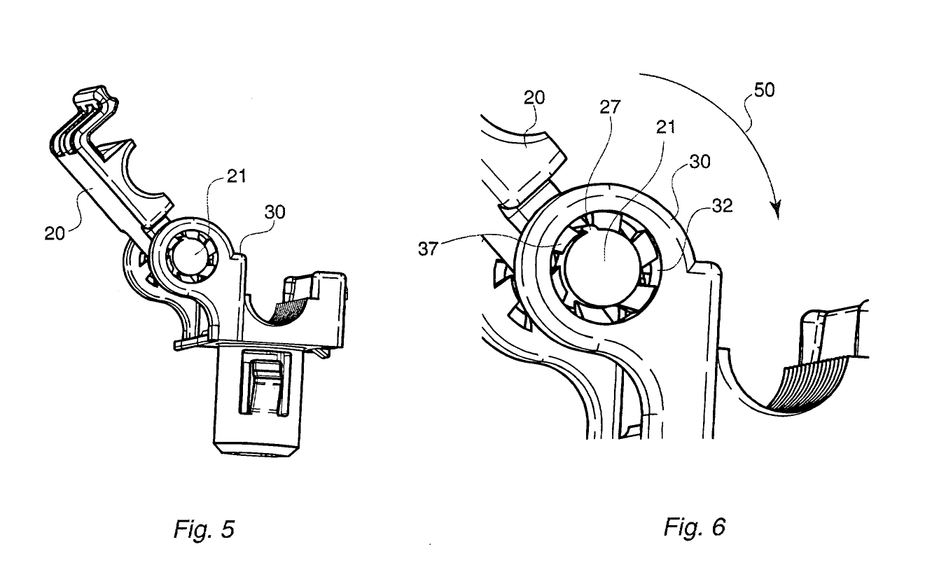

In an alternative embodiment shown in FIGS. 5 and 6, rib 27 and protrusions 37 function form a ratchet, allowing rotation of the hinge in only one direction. This occurs because rib 27 is formed into a curved shape while protrusions 37 are angled toward the curved tip of the rib, so that rib 27 and protrusions 37 interact and protrusions 37 cannot be bypassed in one direction. First section 20 can rotate around second section 30 only in the direction of arrow 50.

Accordingly, while only a few embodiments of the present invention have been shown and described, it is obvious that many changes and modifications may be made thereunto without departing from the spirit and scope of the invention.

What is claimed is:

1. A hinged product comprising:
a first section having a post extending transversely across one end thereof;
a second section having two co-axial apertures therein, each of said apertures having an internal wall, wherein the post on the first section extends through the apertures in the second section to connect the first section to the second section;
at least one protrusion located on one of the post and the internal walls of the apertures; and
at least one rib disposed on one of the apertures and the post, said rib contacting said at least one protrusion as the second section is rotated relative to the first section and causing resistance to rotation.

2. The hinged product according to claim 1, wherein the at least one protrusion is located on the aperture and the at least one rib is disposed along the post.

3. The hinged product according to claim 2, wherein the first section is integrally formed with the second section via at least one connection point connecting the at least one protrusion and the post, wherein rotating the first section relative to the second section causes the at least one connection point to break.

4. The product according to claim 1, wherein the apertures have a plurality of protrusions.

5. The product according to claim 4, wherein the first section can be placed in a selected one of several positions relative to the second section, by rotating the first section relative to the second section to a point where the rib rests between two of the protrusions.

6. The product according to claim 4, wherein the protrusions and the rib form a ratchet mechanism such that the first section rotates relative to the second section in only one direction.

7. The product according to claim 1, wherein the product is a rod clip.

8. The product according to claim 1, wherein the product is formed of injection-molded plastic.

9. The product according to claim 1, wherein there are four protrusions.

10. The product according to claim 1, wherein there are a plurality of ribs.
